(19) United States
(12) Patent Application Publication
(10) Pub. No.: US 2002/0048653 A1
(43) Pub. Date: Apr. 25, 2002

(54) Packaging of Integrated optical devices

(75) Inventor: Karen Emma Todd, Oxford (GB)

Correspondence Address: FLESHNER & KIM, LLP, P.O. Box 221200, Chantilly, VA, 20153-1200, US

(73) Assignee: Bookham Technology PLC

(21) Appl. No.: 09/981,890

(22) Filed: Oct. 19, 2001

(30) Foreign Application Priority Data
Oct. 19, 2000 (GB) 0025599.2

(51) Int. Cl. B32B 23/02

(52) U.S. Cl. 428/194

(57) ABSTRACT

An integrated optical package comprises an integrated optical device in a substantially planar form and a supporting structure, the device being held by the supporting structure in a plurality of fixing regions, the fixing regions being elongate and serving to secure the device in each of the two dimensions of the planar form, at least one edge of the planar form being unfixed. Thus, either two or three edges of the planar form are unfixed, assuming that the device is rectangular. This ensures that one or two edges are free, allowing the device to accommodate stresses by slight relaxation. The device can be held by a heat curable composition, ideally adapted to cure at about the operating temperature of the device. Thus, when the device is operating, the adhesive is substantially at or near its cure temperature. The composition should cure at a temperature within 20° C. of the operating temperature of the device. Given the normal operating temperatures of AWG devices, suitable cure temperatures are between 60 and 90° C., more preferably between 70 and 80° C. or 70 to 75° C. The composition is preferably resilient after curing to assist further in reducing stresses in the device. The application also relates to an integrated optical package comprising an integrated optical device in a substantially planar form, a supporting structure, controlled heating apparatus to elevate the temperature of the device to within a selected temperature range, the device being attached to the supporting structure by a curable composition with a curing temperature within about 20° C. of the selected temperature range.

### FIELD OF THE INVENTION

The present invention relates to the packaging of integrated optical devices.

### BACKGROUND OF THE INVENTION

It particularly, but not exclusively, addresses the problem of fixing the optical device in place within the package. It addresses the demands of optical devices such as arrayed waveguide gratings (AWGs) that work by interference between guided light and which therefore require close dimensional stability. Such stability can be disturbed or destroyed by mechanical stresses in the device or by temperature variations. To alleviate the latter, devices are packaged together with a heater element and a thermistor allied to control circuitry which holds the temperature during use in the range 70-75° C. This can give rise to thermally induced stresses, which the present invention also seeks to address.

### SUMMARY OF THE INVENTION

The present invention therefore provides an integrated optical package comprising an integrated optical device in a substantially planar form, a supporting structure, the device being held by the supporting structure in a plurality of fixing regions, the fixing regions being elongate and serving to secure the device in each of the two dimensions of the planar form, at least one edge of the planar form being unfixed.

Thus, either two or three edges of the planar form are unfixed according to the invention, assuming that the device is rectangular. This ensures that one or two edges are free, allowing the device to accommodate stresses by slight relaxation. However, securing the device in at least two dimensions prevent the device from resonating after physical shock.

Preferably, the device is held by an adhesive. This is preferably a heat curable composition, ideally adapted to cure at about the operating temperature of the device. Thus, when the device is operating, the adhesive is substantially at or near its cure temperature and will not exhibit significant thermal expansion or contraction which might otherwise have exerted mechanical stress on the device. In known arrangements, the device and adhesive cool after curing and this establishes a differential thermal contraction which places both under relative stress. When the device is warmed to its operating temperature, this differential contraction relaxes but not completely. If the cure temperature and the operating temperature are close then during operation, the differential contraction will be minimal. To achieve this, the composition should cure at a temperature within 20° C. of the operating temperature of the device. Given the normal operating temperatures of AWG devices, suitable cure temperatures are between 60 and 90° C., more preferably between 70 and 80° C. or 70 to 75° C.

The composition is preferably resilient after curing. This assists further in reducing stresses in the device. Epoxy resins of this type are known (for other purposes) as low stress epoxy resins.

In another aspect, the present invention also provides an integrated optical package comprising an integrated optical device in a substantially planar form, a supporting structure, controlled heating apparatus to elevate the temperature of the device to within a selected temperature range, the device being attached to the supporting structure by a curable composition with a curing temperature within about 20° C. of the selected temperature range.

Other features of the curable composition in this aspect of the present invention are as set out above in relation to the first aspect and/or are apparent from the description set out herein.

### BRIEF DESCRIPTION OF THE DRAWINGS

Embodiments of the present invention will now be described with reference to the accompanying figures, in which;

FIG. 1 is a plan view of an integrated optical device according to a first embodiment of the present invention;

FIG. 2 is a vertical section on II-II of FIG. 1;

FIG. 3 is a section on III-III of FIG. 1; and

FIG. 4 is a plan view of an integrated optical device according to a second embodiment of the present invention.

### DETAILED DESCRIPTION OF PREFERRED EMBODIMENTS

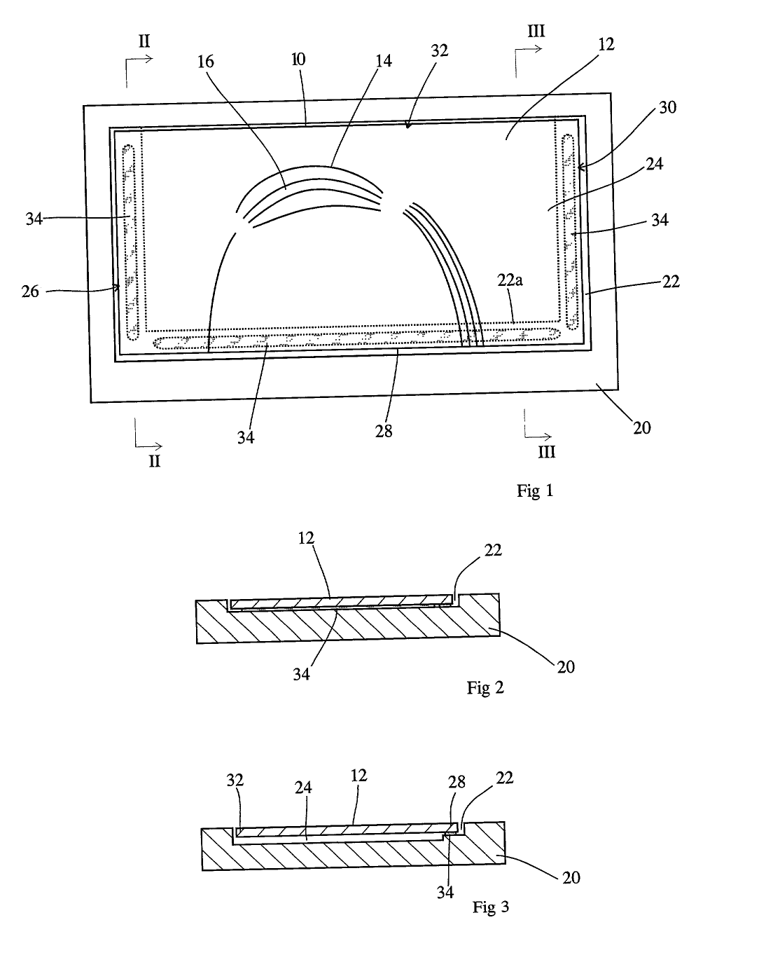

Referring to FIGS. 1 to 3, the integrated optical device 10 comprises a silicon wafer 12 on which are formed waveguides 14 laid out so as to provide an arrayed waveguide grating. The device 10 could of course be constituted in other ways or to provide a different function. However, the device has an active region generally designated as 16 which is sensitive to stress etc. Other regions, for example at the edges of the device 10, do not have a processing function and therefore stress etc in these areas is not such a problem insofar as it does not cause stress in the or an active region.

The device is supported on a ceramic block 20 of a suitable material such as Macor™ or alumina. A first recess 22 is provided in the block 20 which accepts the wafer 12. Within the first recess 22, a second and deeper recess 24 is also provided. The recesses 22, 24 are arranged such that the majority of the wafer 12 lies over the second recess 24 and is thus free floating. Of the four edges of the rectangular wafer 12, three edges 26, 28, 30 rest on the ledge 22a at the periphery of the first recess 22 around the second recess 24. The fourth side 32 is therefore left floating over the second recess 24. The active region 16 is thus suspended or floats over the second recess 24.

The ledge 22 is not essential and could be omitted, relying instead on the thickness of the epoxy layer to support the device and provide clearance beneath.

A layer of adhesive 34 is provided between the surface of the ledge 22a and the underside of the wafer 12 to fix the wafer 12 in place along edges 26, 28, 30. The adhesive is a Resintec™ RT125, a low stress epoxy which cures at 80° C. This is close to the operating temperature of the device, at 70 to 75° C. Accordingly, when operating, the resin adhesive is close to the temperature at which it cured and has little or no residual stress which would otherwise be exerted on the wafer 12. In addition, the low stress nature of the resin adhesive means that it retains some resilience after curing, which assists further in absorbing any residual stresses in the adhesive 34 or the wafer 12.

The adhesive 34 is provided in a series of elongate stripes of between 1 and 10 mm wide, typically 2 mm. These lie along the ledges 22a which support edges 26, 28, 30 of the wafer 12. Alternatively, the adhesive could be spotted along those ledges so as to fix the three edges 26,28, 30.

Since the fourth edge 32 of the wafer 12 is free floating and unattached, it can move slightly to accommodate any residual stresses in the wafer 12. This means that the material at that edge and in an area behind it will be still more free of stress. This area substantially covers the active region 16 thereby allowing the device to operate accurately.

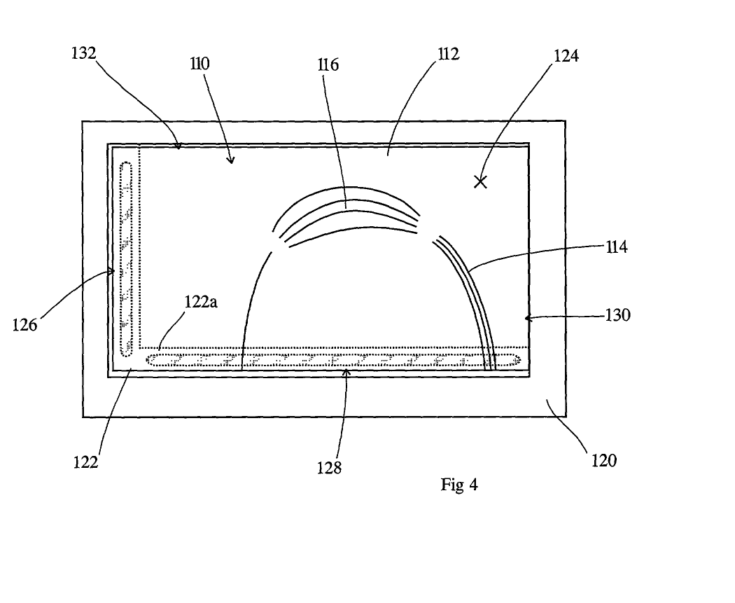

FIG. 4 shows an arrangement that is more suitable for smaller devices 110. A wafer 112 has waveguides 114, again laid out so as to provide an arrayed waveguide grating. The device 110 could of course be constituted in other ways or to provide a different function. However, the device 110 also has an active region generally designated as 116. The smaller size of the wafer 112 means that the active region will inevitably be closer to more of the edges of the wafer.

The device is supported on a ceramic block 120 of a suitable material such as Macor™ or alumina. A first recess 122 is provided in the block 120 which accepts the wafer 112. Within the first recess 122, a second and deeper recess 124 is also provided. The recesses 122, 124 are arranged such that the majority of the wafer 112 lies over the second recess 124 and is thus free floating. Of the four edges of the rectangular wafer 112, in this embodiment only two edges 126, 128, rest on the ledge 122a at the periphery of the first recess 122. The third and fourth sides 130, 132 are therefore left floating over the second recess 124. The active region 116 is thus suspended or floats over the second recess 124.

A layer of adhesive 134 is again provided between the surface of the ledge 122a and the underside of the wafer 112 to fix the wafer 112 in place along edges 126 and 128. The adhesive is as per the first embodiment. Again, the thickness of the adhesive could be used instead of a ledge.

In this embodiment, both the third and fourth edges 30, 32 of the wafer 112 are free floating and unattached. Thus, the stress-free area behind the free edge will be enlarged to accommodate the active region 116.

In both of these embodiments, sufficient of the wafer edge is free to create a low stress region substantially covering the active regions. However, adhesion of the wafer to its support along two dimensions secures the wafer against vibration, such as after a physical shock.

It will be appreciated by those skilled in the art that the above-described embodiments are presented by way of example only, and that many variations can be made to the embodiments without departing from the scope of the present invention. For example, the wafer need not be rectangular but could adopt other geometries such as the circular form from which individual rectangular devices are typically cut, or other shapes. In such cases, so long as the fixing regions secured the wafer in two dimensions and an edge region was left free, the benefits of the invention could be obtained.

1. An integrated optical package comprising;
an integrated optical device in a substantially planar form,
a supporting structure,
the device being held by the supporting structure in a plurality of fixing regions,
the fixing regions being elongate and serving to secure the device in each of the two dimensions of the planar form;
at least one edge of the planar form being unfixed.

2. An integrated optical device as claimed in claim 1 in which the device has a rectangular form, two edges of which are unfixed.

3. An integrated optical device as claimed in claim 1 in which the device has a rectangular form, one edge of which is unfixed.

4. An integrated optical device as claimed in claim 1 in which the device is held in place by a curable adhesive composition.

5. An integrated optical device as claimed in claim 4 in which the composition is adapted to cure at about the operating temperature of the device.

6. An integrated optical device as claimed in claim 4 in which the composition is adapted to cure at a temperature within 20° C. of the operating temperature of the device.

7. An integrated optical device as claimed in claim 4 in which the composition is adapted to cure at a temperature of between 60 and 90° C.

8. An integrated optical device as claimed in claim 4 in which the composition is adapted to cure at a temperature of between 70 and 80° C.

9. An integrated optical device as claimed in claim 4 in which the composition is adapted to cure at a temperature of between 70 and 75° C.

10. An integrated optical device as claimed in claim 4 in which the composition is resilient after curing.

11. An integrated optical device as claimed in claim 4 in which the conforming adhesive is an epoxy resin.

12. An integrated optical device as claimed in claim 11 in which the epoxy is a low stress epoxy resin.

13. An integrated optical package comprising;
an integrated optical device in a substantially planar form,
a supporting structure,
controlled heating apparatus to elevate the temperature of the device to within a selected temperature range,
the device being attached to the supporting structure by a curable composition with a curing temperature within about 20° C. of the selected temperature range.

14. An integrated optical device as claimed in claim 13 in which the curable composition is adapted to cure at a temperature of between 60 and 90° C.

15. An integrated optical device as claimed in claim 13 in which the curable composition is adapted to cure at a temperature of between 70 and 80° C.

16. An integrated optical device as claimed in claim 13 in which the curable composition is adapted to cure at a temperature of between 70 and 75° C.

17. An integrated optical device as claimed in claim 13 in which the curable composition is resilient after curing.

18. An integrated optical device as claimed in claim 13 in which the curable composition is an epoxy resin.

19. An integrated optical device as claimed in claim 18 in which the epoxy is a low stress epoxy resin.
